(19) United States
(12) Patent Application Publication
(10) Pub. No.: US 2016/0014658 A1
(43) Pub. Date: Jan. 14, 2016

(54) METHOD AND APPARATUS FOR AVOIDING CALL DROPS DURING SERVING RADIO NETWORK SUBSYSTEM (SRNS) RELOCATION PROCEDURE

(71) Applicants: Huan XU, San Diego, CA (US); Xuepan GUAN, San Diego, CA (US); Tim Tynghuei LIOU, San Diego, CA (US); Shiau-He TSAI, San Diego, CA (US); Yong XIE, San Diego, CA (US); QUALCOMM INCORPORATED, San Diego, CA (US)

(72) Inventors: Huan XU, San Diego, CA (US); Xuepan GUAN, Beijing (CN); Tim Tynghuei LIOU, San Diego, CA (US); Shiau-He TSAI, San Diego, CA (US); Yong XIE, Beijing (CN)

(21) Appl. No.: 14/759,882

(22) PCT Filed: May 21, 2013
(86) PCT No.: PCT/CN2013/075975

§ 371 Date: Jul. 8, 2015

(30) Foreign Application Priority Data
Apr. 2, 2013 (CN) PCT/CN2013/073636

(51) Int. Cl. H04W 36/08; H04W 76/04; H04W 72/04

(52) U.S. Cl. CPC H04W 36/08; H04W 72/042; H04W 72/0413; H04W 76/046

(57) ABSTRACT

A method and apparatus for avoiding call drops during Serving Radio Network Subsystem (SRNS) relocation procedure are described. In an aspect, the method may include receiving an SRNS RELOCATION message and initiating a handover procedure from a first radio network subsystem (RNS) to a second RNS based on the SRNS RELOCATION message. The method may include identifying a downlink (DL) message and identifying an uplink (UL) message. The method may include holding the DL message and the UL message at a radio resource control (RRC) layer until completion of the handover procedure. In another aspect, the SRNS RELOCATION message may include a new FRESH value. The method may include retaining an old FRESH value determined before the SRNS RELOCATION was received. The method may include applying both the old FRESH value and new FRESH value to the DL message to determine if the DL message is valid.

### CLAIM OF PRIORITY UNDER PATENT COOPERATION TREATY (PCT) ARTICLE 8

The present Application for patent claims priority to PCT Application No. PCT/CN2013/073636 entitled “METHOD AND APPARATUS FOR AVOIDING CALL DROPS DURING SERVING RADIO NETWORK SUBSYSTEM (SRNS) RELOCATION PROCEDURE” filed Mar. 28, 2013 in the Chinese Receiving Office (RO/CN), and assigned to the assignee hereof and hereby expressly incorporated by reference herein.

### BACKGROUND

1. Field

Aspects of the present disclosure relate generally to wireless communications and, more particularly, to a method and apparatus for avoiding call drops during a Serving Radio Network Subsystem (SRNS) relocation procedure.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

Serving Radio Network Subsystem (SRNS) relocation is a procedure used when a mobile terminal (also referred to as a user equipment (UE)) performs a handover from one Radio Network Subsystem (RNS) to another RNS in UMTS. During an SRNS relocation procedure, a mobile terminal may be in an SRNS pending state. An SRNS pending state may be a timeframe, or window, starting when a mobile terminal receives an SRNS RELOCATION message from the network, and ending when the mobile terminal sends an SRNS RELOCATION COMPLETE message to the network. During an SRNS pending state, the 3GPP 25.331 specification (e.g., 3GPP Technical Specification 25.331 Radio Resource Control (RRC); Protocol Specification, which is incorporated herein by reference in its entirety), provides that the mobile terminal perform re-establishment of the Radio Link Control (RLC) Acknowledged Mode (AM) entity for all Signaling Radio Bearers (SRB).

During RLC AM re-establishment, downlink (DL) and/or uplink (UL) messages (e.g., partially-transmitted response messages) on SRBs (e.g., SRB 3/4) from/to the network (e.g., the SRNC) may be dropped. The 3GPP 25.331 specification does not provide that the mobile terminal and/or the target RNC should attempt to recover such dropped SRB messages. The impact of not recovering the dropped messages could be a call drop for either a packet-switched or circuit-switched call if the dropped messages, are critical.

To avoid this situation, ideally, both the mobile terminal and the network should avoid sending SRB messages during the SRNS pending state. However, in a TD-SCDMA network (e.g., 1.28 Megachips per second (MCPs) Time-Division Duplex (TDD) version of UMTS), it is observed that the network may continue to send SRB 3/4 messages to mobile terminals during the SRNS relocation pending state. This may occur due to bad scheduling or re-transmission at the RLC layer.

In addition to the possible loss of the message itself, other issues may be presented for DL messages received at the mobile terminal during an SRNS pending state. First, it may be unclear whether an old or new FRESH value should be applied to such DL messages for integrity protection purposes. For instance, a FRESH value may be a randomly-generated number used to integrity protect DL and UL messages. A UE may receive a FRESH value from the network in association with certain security-related configuration messages and/or an SRNS RELOCATION message. In an example, the UE may receive a DL message from the network, which includes a FRESH value. The UE may apply the FRESH value known to the UE (which it may have previously received from the network) to validate the DL message. If the FRESH value known to the UE matches the FRESH value associated with the DL message by the network (e.g., the DL message is integrity protected by the network with the associated FRESH value), the DL message may be deemed valid.

Regarding this first issue, the 3GPP 25.331 specification provides that a new FRESH value should be applied by the mobile terminal after receipt of an SRNS RELOCATION message. However, the 3GPP 25.331 specification does not specify which FRESH value (e.g., the old, pre-SRNS RELOCATION message value, or the new, post-SRNS RELOCATION message value) the mobile terminal should apply when checking the integrity of DL messages sent by the SRNC, and received at the mobile terminal, during the SRNS relocation pending state. As such, there are two possibilities for a FRESH value mis-match between the network and the mobile terminal: (1) for messages (e.g., messages on SRB 3/4 destined for upper layers, such as the Non-Access Stratum (NAS) layer) that were scheduled by a currently-serving (or source) RNC before the SRNS RELOCATION message was received at the mobile terminal, but arrive at the mobile terminal later than the SRNS RELOCATION message (e.g., due to RLC re-transmission delay), there will be ambiguity as to which FRESH value should be applied to those messages by the mobile terminal, and (2) for messages that were scheduled after the SRNS RELOCATION message was scheduled by the source RNC, and arrive at the mobile terminal later than the SRNS RELOCATION message, there will be ambiguity as to which FRESH value should be applied to those messages by the mobile terminal. From the point of view of the mobile terminal, these two scenarios have the same effect—a message is received during the SRNS relocation pending state.

If the mobile terminal uses a mis-matched FRESH value for integrity protection, the DL message may be dropped due to an integrity check error (e.g., the FRESH value applied does not match the FRESH value associated with the DL message), which may further result in a call drop. For example, in some TD-SCDMA networks, the network (e.g., at the SRNC) may integrity protect the DL message using an old FRESH value. However, and in such an example, the mobile terminal Radio Resource Control (RRC) Layer, which handles the integrity check, will always choose to use the new FRESH value as provided by the specification. As such, there will be a FRESH mis-match, an integrity check error, and a resulting call drop.

Second, UL response messages (e.g., responses to received DL messages) initiated during the SRNS relocation pending state also may be lost due to partial transmission before the RLC AM entity re-establishment.

Regarding this second issue, for any DL SRB 3/4 messages received during the SRNS relocation pending state, which successfully pass the integrity check, the RRC layer forwards the messages to a higher layer (e.g., NAS layer). A response message from the higher layer may be returned to the RRC layer during the SRNS pending state. As such, the response message may be dropped due to, for example, partial transmission before RLC AM entity re-establishment. This may result in a call drop.

As such, improvements in integrity checking of DL SRB messages and UL SRB response message transmission during SRNS relocation pending state are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Various aspects for avoiding call drops during Serving Radio Network Subsystem (SRNS) relocation procedure are described.

In an aspect, a method for wireless communication is described. The method may include receiving a Serving Radio Network Subsystem (SRNS) RELOCATION message. The method may include initiating a handover procedure from a first radio network subsystem (RNS) to a second RNS based on the SRNS RELOCATION message. The method may include identifying a downlink (DL) message. The method may include identifying an uplink (UL) message. The method may include holding the DL message and the UL message at a radio resource control (RRC) layer until completion of the handover procedure.

In an aspect, a method for wireless communication is described. The method may include receiving a Serving Radio Network Subsystem (SRNS) RELOCATION message. The SRNS RELOCATION message may include a new FRESH value. The method may include retaining an old FRESH value determined before the SRNS RELOCATION was received. The method may include receiving a downlink (DL) message. The method may include applying both the old FRESH value and new FRESH value to the DL message to determine if the DL message is valid.

In an aspect, a computer program product comprising a computer readable medium is described. The computer readable medium may include code. The code may cause at least one computer to receive a Serving Radio Network Subsystem (SRNS) RELOCATION message. The code may cause at least one computer to initiate a handover procedure from a first radio network subsystem (RNS) to a second RNS based on the SRNS RELOCATION message. The code may cause at least one computer to identify a downlink (DL) message. The code may cause at least one computer to identify an uplink (UL) message. The code may cause at least one computer to hold the DL message and the UL message at a radio resource control (RRC) layer until completion of the handover procedure.

In an aspect, a computer program product comprising a computer readable medium is described. The computer readable medium may include code. The code may cause at least one computer to receive a Serving Radio Network Subsystem (SRNS) RELOCATION message. The SRNS RELOCATION message may include a new FRESH value. The code may cause at least one computer to retain an old FRESH value determined before the SRNS RELOCATION was received. The code may cause at least one computer to receive a downlink (DL) message. The code may cause at least one computer to apply both the old FRESH value and new FRESH value to the DL message to determine if the DL message is valid.

In an aspect, an apparatus for wireless communication is described. The apparatus may include means for receiving a Serving Radio Network Subsystem (SRNS) RELOCATION message. The apparatus may include means for initiating a handover procedure from a first radio network subsystem (RNS) to a second RNS based on the SRNS RELOCATION message. The apparatus may include means for identifying a downlink (DL) message. The apparatus may include means for identifying an uplink (UL) message. The apparatus may include means for holding the DL message and the UL message until completion of the handover procedure.

In an aspect, an apparatus for wireless communication is described. The apparatus may include means for receiving a Serving Radio Network Subsystem (SRNS) RELOCATION message. The SRNS RELOCATION message may include a new FRESH value. The apparatus may include means for retaining an old FRESH value determined before the SRNS RELOCATION was received. The apparatus may include means for receiving a downlink (DL) message. The apparatus may include means for applying both the old FRESH value and new FRESH value to the DL message to determine if the DL message is valid.

In an aspect, an apparatus for wireless communication is described. The apparatus may include at least one memory. The apparatus may include a Serving Radio Network Subsystem (SRNS) relocation component configured to receive a Serving Radio Network Subsystem (SRNS) RELOCATION message, and initiate a handover procedure from a first radio network subsystem (RNS) to a second RNS based on the SRNS RELOCATION message. The apparatus may include a message holding component configured to identify a downlink (DL) message, identify an uplink (UL) message, and hold the DL message and the UL message until completion of the handover procedure.

In an aspect, an apparatus for wireless communication is described. The apparatus may include at least one memory. The apparatus may include a Serving Radio Network Subsystem (SRNS) relocation component configured to receive a Serving Radio Network Subsystem (SRNS) RELOCATION message. The SRNS RELOCATION message may include a new FRESH value. The apparatus may include an integrity protection component configured to retain an old FRESH value determined before the SRNS RELOCATION was received. The integrity protection component may be configured to receive a downlink (DL) message. The integrity protection component may be configured to apply both the old FRESH value and new FRESH value to the DL message to determine if the DL message is valid.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a block diagram illustrating a wireless communication system, including a user equipment (UE) in communication with two Node Bs;

FIG. 2 is a block diagram of an integrity protection component within a UE;

FIG. 3 is a flow chart of a method for integrity checking messages;

FIG. 4 is a block diagram of a message holding component within a UE;

FIG. 5 is a flow chart of a method for wireless communication, including avoiding call drops during a Serving Radio Network Subsystem (SRNS) pending state;

FIG. 6 is a flow chart of a method for wireless communication, including an integrity check during an SRNS pending state;

FIG. 7 is a block diagram illustrating an example of a hardware implementation for an apparatus employing a processing system;

FIG. 8 is a block diagram illustrating an example of a telecommunications system;

FIG. 9 is a diagram illustrating an example of an access network;

FIG. 10 is a diagram illustrating an example of a radio protocol architecture for the user and control plane; and

FIG. 11 is a block diagram illustrating an example of a Node B in communication with a UE in a telecommunications system.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

According to the described aspects, a new behavior is introduced to avoid dropped calls as a result of a mis-matched FRESH value used by a mobile terminal and/or for an uplink (UL) higher layer transmission during a Serving Radio Network Subsystem (SRNS) relocation procedure, as per the 3GPP TS 25.331 specification (3GPP Technical Specification 25.331 Radio Resource Control (RRC); Protocol Specification, which is incorporated herein by reference in its entirety).

SRNS relocation is a procedure used when a mobile terminal, or user equipment (UE), performs a handover from one Radio Network Subsystem (RNS) to another RNS in UMTS. During an SRNS relocation procedure, a mobile terminal may be in an SRNS pending state. An SRNS pending state may be a timeframe, or window, starting when a mobile terminal receives an SRNS RELOCATION message from the network, and ending when the mobile terminal sends an SRNS RELOCATION COMPLETE message to the network. During an SRNS pending state, the 3GPP TS 25.331 specification, provides that the mobile terminal performs re-establishment of the Radio Link Control (RLC) Acknowledged Mode (AM) entity for all Signaling Radio Bearers (SRB).

A FRESH value may be a randomly-generated number used to integrity protect DL and UL messages. A UE may receive a FRESH value from the network in association with certain security-related configuration messages or an SRNS RELOCATION message. In an example, the UE may receive a DL message from the network, which includes a FRESH value. The UE may apply the FRESH value known to the UE (which it may have previously received from the network) to validate the DL message. If the FRESH value known to the UE matches the FRESH value associated with the DL message by the network, the DL message may be deemed valid.

The 3GPP 25.331 specification provides that a new FRESH value should be applied by the mobile terminal after receipt of an SRNS RELOCATION message, which includes the new FRESH value. However, the 3GPP 25.331 specification does not specify which FRESH value (e.g., the old, pre-SRNS RELOCATION message value, or the new, post-SRNS RELOCATION message value) the mobile terminal should apply when checking the integrity of DL messages sent by the SRNC, and received at the mobile terminal, during the SRNS relocation pending state. As such, there are two possibilities for a FRESH value mis-match between the network and the mobile terminal: (1) for messages (e.g., messages on SRB 3/4 destined for upper layers, such as the Non-Access Stratum (NAS) layer) that were scheduled before the SRNS RELOCATION message was received at the mobile terminal, but arrive at the mobile terminal later than the SRNS RELOCATION message (e.g., due to RLC re-transmission delay), there will be ambiguity as to which FRESH value should be applied to those messages by the mobile terminal, and (2) for messages that were scheduled after the SRNS RELOCATION message was scheduled by the source RNC, and arrive at the mobile terminal later than the SRNS RELOCATION message, there will be ambiguity as to which FRESH value should be applied to those messages by the mobile terminal From the point of view of the mobile terminal, these two scenarios have the same effect—a message is received during the SRNS relocation pending state.

If the mobile terminal uses a mis-matched FRESH value, the DL message may be dropped due to an integrity check error (e.g., the FRESH value applied does not match the FRESH value associated with the DL message), which may further result in a call drop. For example, in some TD-SCDMA networks, the network (e.g., at the SRNC) may integrity check a DL message using an old FRESH value. However, and in such an example, the mobile terminal Radio Resource Control (RRC) Layer, which handles the integrity check, will always choose to use the new FRESH value as provided by the 3GPP TS 25.331 specification. As such, there will be a FRESH mis-match, an integrity check error, and a resulting call drop.

To avoid use by the mobile terminal of a mis-matched FRESH value, according to an aspect, the present apparatus and methods may configure the RRC layer at the mobile terminal side to apply both the new and old FRESH values to DL messages received at the mobile terminal during an SRNS pending state. In other words, for DL messages received by the mobile terminal after receipt of an SRNS RELOCATION message, but before completion of the SRNS relocation procedure, the mobile terminal may apply both the new and old FRESH values to integrity check the DL messages. If either of the new or old FRESH values match the FRESH value associated with the DL message, the DL message passes the integrity check and is treated as a valid DL message.

Additionally, for any DL SRB 3/4 messages received during the SRNS relocation pending state, which successfully pass the integrity check, the RRC layer forwards the messages to a layer that is higher than the RRC layer (e.g., the NAS layer). A UL SRB 3/4 response message from the higher layer may be returned to the RRC layer by the NAS layer during the SRNS pending state. As such, the response message may be dropped due to, for example, partial transmission. This may result in a call drop.

To avoid dropped UL response messages on SRB 3/4 due to, for example, the RLC re-establishment, according to an aspect, the present apparatus and methods may configure the RRC layer at the mobile terminal to perform two actions. First, if a DL SRB 3/4 message is received during the SRNS relocation pending state, the RRC layer may hold the DL message until the RLC re-establishment for the SRB 3/4 is completed. The RRC layer then may provide the DL message to the higher layer (e.g., the NAS layer), which, in response, sends a UL response message to the RRC layer. As such, the UL response message will not be dropped before arriving at the RRC layer. Second, if a higher layer response message has been initiated and passed to the RRC layer for UL transmission on SRB 3/4, the RRC layer may hold the higher layer UL response message until after completion of the RLC re-establishment for SRB 3/4.

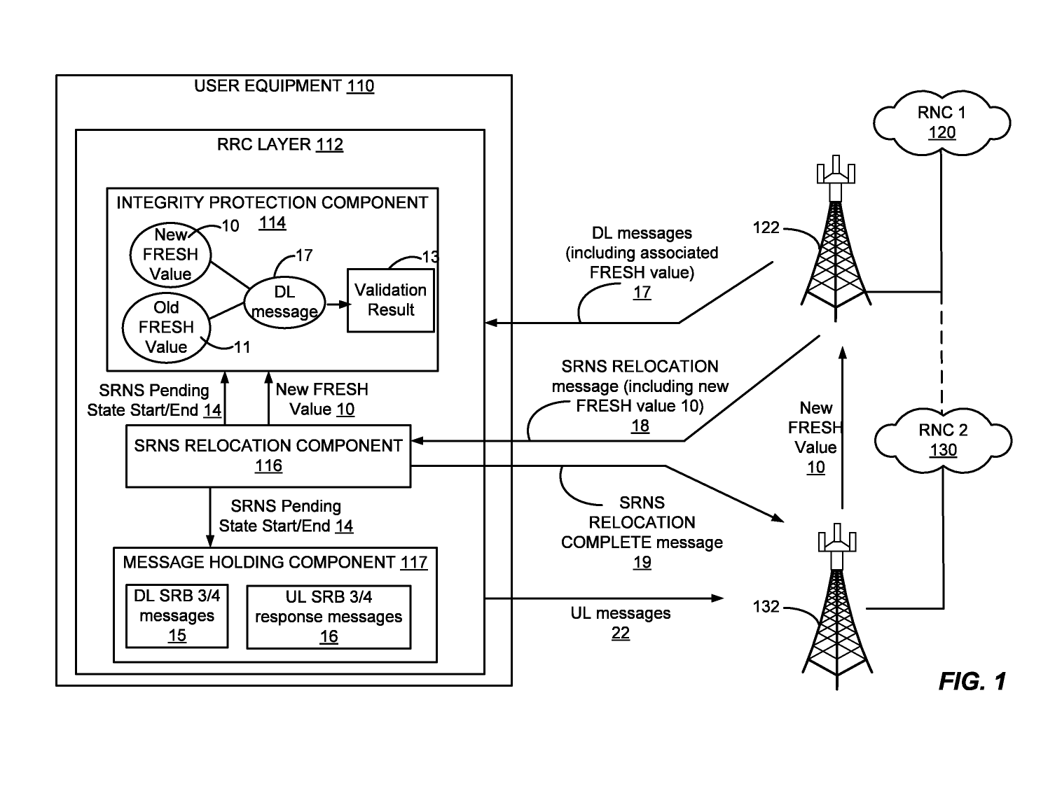

Referring to FIG. 1, a user equipment (UE) 110 is being served by a first Node B 122 associated with a first radio network controller (RNC) 120 when the UE 110 receives a Serving Radio Network Subsystem (SRNS) RELOCATION message 18 from Node B 122 indicating that the UE 110 is to perform an SRNS relocation from Node B 122 to Node B 132 associated with a second RNC 130.

A mobile device, such as UE 110, also may be referred to as a system, subscriber unit, subscriber station, mobile station, mobile, remote station, remote terminal, access terminal, user terminal, terminal, wireless communication device, user agent, or user device. A mobile device can be a cellular telephone, a cordless telephone, a Session Initiation Protocol (SIP) phone, a wireless local loop (WLL) station, a personal digital assistant (PDA), a handheld device having wireless connection capability, computing device, or other processing device connected to a wireless modem.

Node B 122 and/or Node B 132 may be referred to as a base station, and may be a macrocell, picocell, femtocell, relay, Node B, mobile Node B, UE (e.g., communicating in peer-to-peer or ad-hoc mode with UE 110), or substantially any type of component that can communicate with UE 110 to provide wireless network access.

The SRNS RELOCATION message 18 may include information from the first RNC 120 and the second RNC 130. For example, Node B 122 may communicate with Node B 132 prior to sending the SRNS RELOCATION message 18 to UE 110 to determine a new FRESH value 10 to be included in the SRNS RELOCATION message 18. In another example, SRNS RELOCATION message 18 may also include other information that may be used by UE 110 to perform the relocation procedure. Upon receiving the SRNS RELOCATION message 18, UE 110 begins to re-establish the Radio Link Control (RLC) layer. The window of time between receipt of the SRNS RELOCATION message 18 by the UE 110 and the completion of the SRNS relocation (when UE 110 may send SRNS RELOCATION COMPLETE message 19) may be referred to as an SRNS relocation pending state or SRNS relocation window.

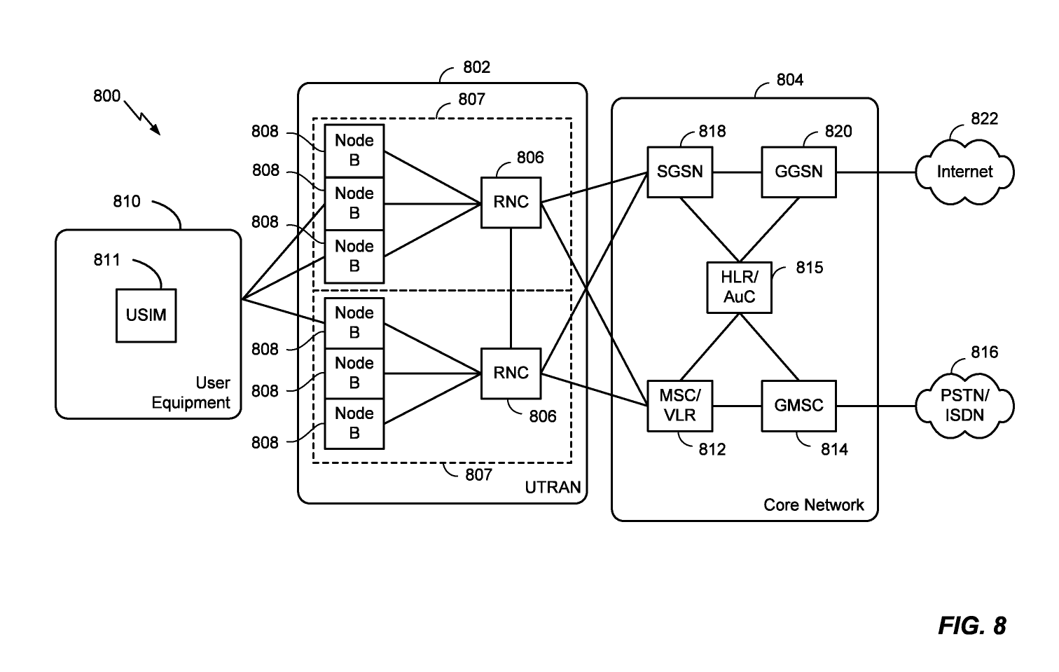

UE 110 includes Radio Resource Control (RRC) layer 112. RRC layer 112 is a protocol entity within the UMTS W-CDMA protocol stack, which handles control plane signaling of Layer 3 between the UE 110 and the UTRAN (such as, for example, UTRAN 802 described herein with respect to FIG. 8).

RRC layer 112 includes SRNS relocation component 116, which may be configured to receive, process, and handle an SRNS RELOCATION message 18 received by UE 110 from Node B 122, which is currently serving the UE 110. The Node B 122 may communicate with Node B 132 associated with a second RNC 130, to which the UE 110 is to be handed over, to determine a new FRESH value 10. The SRNS RELOCATION message 18 may include a new FRESH value 10 to be used by the UE 110 for integrity protection.

SRNS relocation component 116 may be configured to determine a start and end of an SRNS pending state based on receiving SRNS RELOCATION message 18 (including new FRESH value 10) and sending SRNS RELOCATION COMPLETE message 19 back to the network (e.g., new serving Node B 132) once the SRNS relocation procedure is complete. In a non-limiting example, SRNS relocation component 116 may be configured to set a flag, or some other SRNS pending state indicator, when UE 110 enters an SRNS pending state, and unset the flag, or other SRNS pending state indicator, when the UE 110 has completed the SRNS handover procedure and is no longer in an SRNS pending state. In an aspect, SRNS relocation component 116 may be configured to notify other components within (and/or outside) UE 110 (e.g., integrity protection component 114 and message holding component 117) that the UE 110 is in an SRNS pending state. In another aspect, and in addition or in the alternative, SRNS relocation component 116 may be configured to respond to SRNS pending state inquiries from other components within (and/or outside) UE 110 (e.g., integrity protection component 114 and message holding component 117). In any case, SRNS relocation component 116 may be configured to share SRNS pending state start/end information 14 with other components that may rely on such information. SRNS relocation component 116 may be configured to provide the new FRESH value 10 to integrity protection component 114.

In an aspect, RRC layer 112 includes integrity protection component 114, which may be configured to receive a DL message 17, apply one or more FRESH values stored at UE 110 (e.g., old FRESH value 11 and/or new FRESH value 10 stored in a memory or other storage device which may be a part of or in communication with integrity protection component 114) to the incoming DL message 17 determine if the DL message 17 is valid, and output a validation result 13. As described above, the network (via the Node B 122) may continue to integrity protect DL messages sent to UE 110 with an old FRESH value 11 even though the Node B 122 has sent an SRNS RELOCATION message 18 (e.g., has informed UE 110 to start an SRNS handover to Node B 132), to UE 110, which includes, and is integrity protected by, a new FRESH value 10. In such a case, and as provided by the 3GPP TS 25.331 specification, UE 110 would apply the new FRESH value 10 it received as part of the SRNS RELOCATION message 18 to a DL message 17 that was integrity protected by the network with an old FRESH value 11 and, as such, the DL message 17 would be deemed invalid and dropped. To avoid dropping valid messages during an SRNS pending state, and in an aspect, integrity protection component 114 may be configured to apply both the old FRESH value 11 and the new FRESH value 10 to the DL message 17 to perform the integrity check. If either the old FRESH value 11 or the new FRESH value 10 are a match for the FRESH value associated with the DL message 17, then integrity protection component 114 may determine that DL message 17 is valid. In an aspect, prior to determining whether there is a match, the integrity protection component 114 may be configured to determine whether the UE 110 is in an SRNS pending state by communicating with SRNS relocation component 116 and receiving SRNS pending state start/end information 14.

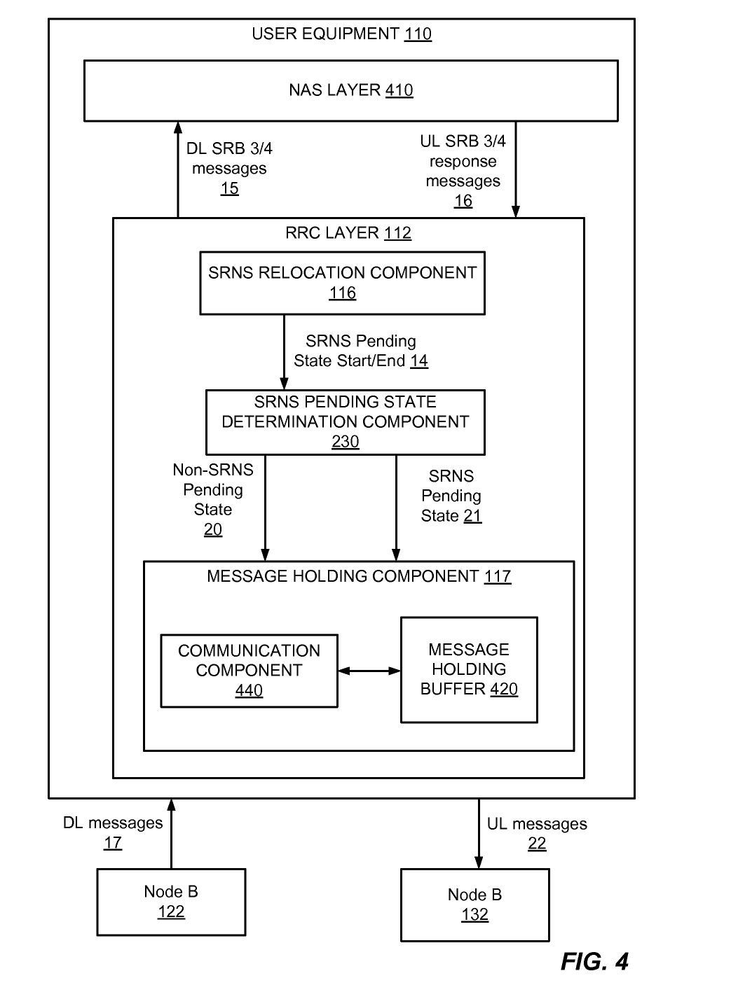

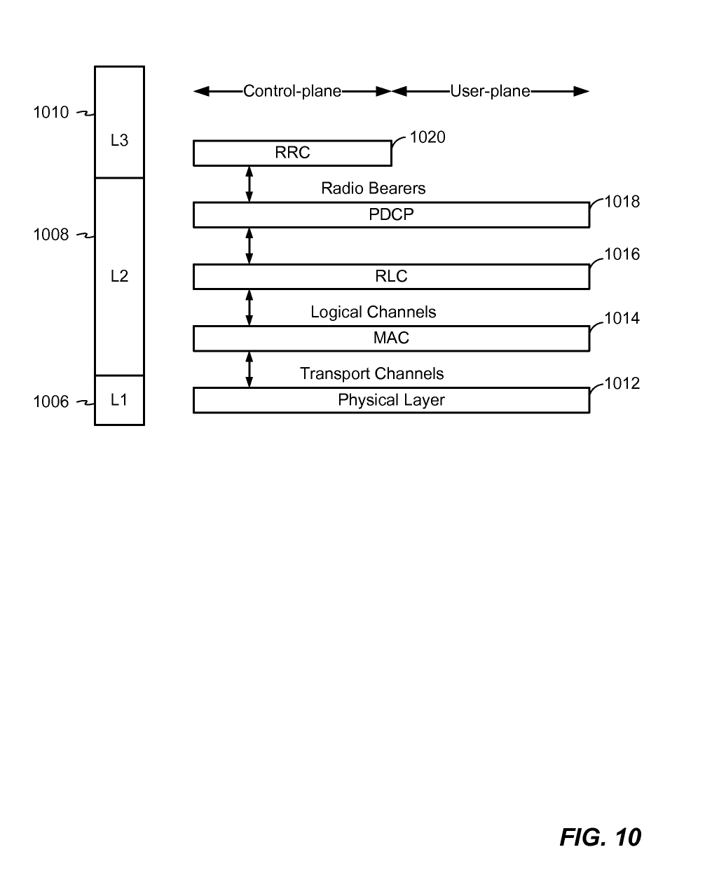

In an aspect, RRC layer 112 includes message holding component 117, which may include or be in communication with a memory or other storage device that may be configured to hold messages during an SRNS pending state to avoid message drops. In an aspect, message holding component 117 may be configured to communicate with SRNS relocation component 116 to determine if the UE 110 is in an SRNS pending state by requesting and/or receiving SRNS pending state start/end information 14. If so, and in an aspect, message holding component 117 may be configured to identify, and/or intercept, DL SRB 3/4 messages 15 received at the UE 110 from Node B 122, which are destined for a higher layer, e.g., the non-access stratum (NAS) layer (e.g., NAS layer 410 described herein with respect to FIG. 4). In an aspect, DL messages 17 may be DL SRB 3/4 messages 15. The NAS layer is a functional layer in the UMTS protocol stack between the core network (e.g., CN 804 described herein with respect to FIG. 8) and UE 110. The NAS layer manages the establishment of communication sessions and maintains continuous communications with the UE 110 as it moves. The NAS is defined in contrast to the Access Stratum, which includes the RRC layer 112, a Radio Link Control (RLC) layer, a Medium Access Control (MAC) layer, and a physical layer, which is responsible for carrying information over the wireless portion of the network (only RRC layer 112 is shown in FIG. 1, but the additional layers are described herein with respect to FIG. 10). Message holding component 117 may be configured to hold any identified DL SRB 3/4 messages 15 during an SRNS pending state, e.g., until the SRNS relocation is complete, at which point the messages holding component 117 may be configured to transmit the held DL SRB 3/4 messages 15 to the NAS layer. By holding DL SRB 3/4 messages 15 during an SRNS pending state, UE 110 and/or message holding component 117 helps assure that the DL SRB 3/4 messages 15 arrive safely at the NAS layer and that any response messages sent from the NAS layer (e.g., UL SRB 3/4 response messages 16) arrive safely at RRC layer 112.

In another aspect, message holding component 117 may be configured to identify, and/or intercept, UL SRB 3/4 response messages 16 scheduled by the NAS layer for transmission to the network on the UL. In an aspect, UL messages 22 may be UL SRB 3/4 response messages 16. Such UL SRB 3/4 response messages 16 and/or UL messages 22 may be, for example, response messages to DL message 17 and/or DL SRB 3/4 messages 15 received at UE 110 (e.g., at the NAS layer). Message holding component 117 may be configured to hold any identified UL SRB 3/4 response messages 16 during an SRNS pending state, e.g., until the SRNS relocation is complete, at which point the message holding component 117 may be configured to send the held UL SRB 3/4 response messages 16 to lower layers for transmission to the network (e.g., Node B 132 associated with the second RNC 130). By holding UL SRB 3/4 response messages 16 during an SRNS pending state, UE 110 and/or message holding component 117 helps assure that the UL SRB 3/4 response messages 16 are sent to the network and received at the proper Node B (e.g., Node B 132), upon completion of the RNC handover from the first RNC 120 to the second RNC 130.

Upon completion of an SRNS relocation procedure, SRNS relocation component 116 may be configured to send an SRNS RELOCATION COMPLETE message 19 to the network. SRNS relocation component 116 also may be configured to notify, or respond to an inquiry from, other components of UE 110 (e.g., integrity protection component 114 and message holding component 117) that the UE 110 is no longer in an SRNS pending state via SRNS pending state start/end information 14. In an aspect, such notification may allow integrity protection component 114 to discard any old FRESH values 11 currently being used and apply only the new FRESH value 10 to future incoming DL messages 17 during integrity checking. In another aspect, such notification may allow UL SRB 3/4 response messages 16 and DL SRB 3/4 messages 15 to proceed in the normal course, without being held, and, for example, by bypassing message holding component 117.

It should be noted that one or more components of UE 110, such as but not limited to RRC layer 112, integrity protection component 114, SRNS relocation component 116, and message holding component 117, may be configured in hardware, software stored in a memory (e.g., a non-transitory computer-readable medium), firmware, or any combination thereof, and may be executable within or in combination with a processor.

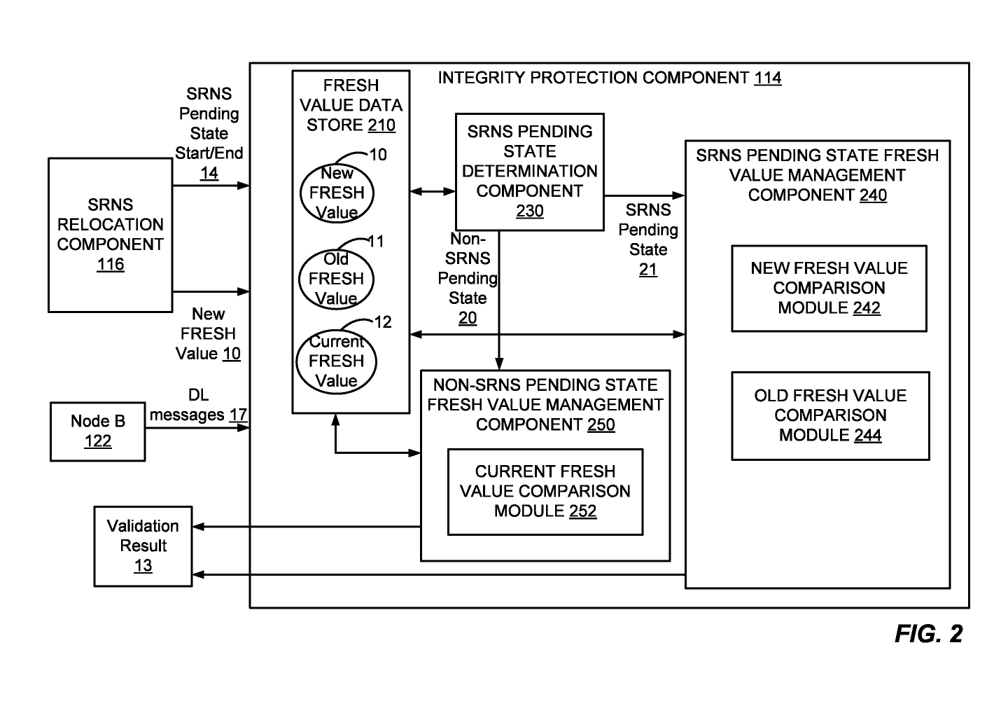

Referring to FIG. 2, in an aspect, integrity protection component 114 is in communication with SRNS relocation component 116 and receives DL messages 17 from the network (e.g., from a currently serving Node B 122). Integrity protection component 114 may be configured to determine if a DL message 17, which includes an associated FRESH value, received by UE 110 from the network is valid by, for example, comparing the FRESH value associated with the DL message 17 to a FRESH value previously communicated to UE 110 to determine whether the values are the same (e.g., a match) or different (e.g., a mis-match). Integrity protection component 114 may be configured to receive DL messages 17 from Node B 122, receive SRNS pending state start/end information 14 and new FRESH value 10, both from SRNS relocation component 116, apply new FRESH value 10 and/or old FRESH value 11 (based on the SRNS pending state start/end information 14) to DL message 17, and determine a validation result 13. If the DL message 17 is deemed to be valid, it may be provided to other components within UE 110 for processing. If the DL message 17 is deemed to be invalid, it may be dropped.

Integrity protection component 114 includes FRESH value data store 210, which may be configured to receive FRESH values from SRNS RELOCATION component 116 each time a new FRESH value 10 is received by UE 110 from the network (e.g., its current serving Node B 122). FRESH value data store 210 may be configured to store FRESH values (e.g., old FRESH value 11 and new FRESH value 10), and provide the FRESH values to SRNS pending state FRESH value management component 240 and non-SRNS pending state FRESH value management component 250. In an aspect, FRESH value data store 210 may be configured to communicate with SRNS pending state determination component 230 to determine whether UE 110 is currently in an SRNS pending state and, as such, only send FRESH values to a corresponding management component. In other words, and in the aspect, if FRESH value data store 210 determines that UE 110 is in an SRNS pending state, it may provide FRESH values to SRNS pending state FRESH value management component 240; if FRESH value data store 210 determines that the UE 110 is not in an SRNS pending state, it may provide FRESH value(s) to non-SRNS pending state FRESH value management component 250. In another aspect, FRESH value data store 210 may be configured to provide FRESH value(s) to both SRNS pending state FRESH value management component 240 and non-SRNS pending state FRESH value management component 250 regardless of whether UE 110 is in an SRNS pending state or not.

In an aspect, during an SRNS pending state, which may be determined by SRNS pending state determination component 230, FRESH value data store 210 may continue to store an old FRESH value 11 (e.g., in a buffer). FRESH value data store 210 also may store (e.g., in a buffer) a new FRESH value 10 provided as part of a present SRNS RELOCATION message 18 received by UE 110 from Node B 122. The new FRESH value 10 may be provided to integrity protection component 114 and/or SRNS pending state determination component 230, by SRNS relocation component 116 as SRNS pending state start/end information 14. In an aspect, when the SRNS relocation procedure is complete, FRESH value data store 210 may be configured to discard, or otherwise make unavailable, any old FRESH values 11 that were being stored and/or used by FRESH value data store 210.

Integrity protection component 114 includes SRNS pending state determination component 230, which may be configured to receive and/or request a notification from SRNS relocation component 116 when the UE 110 enters an SRNS pending state. In an example, SRNS relocation component 116 may provide SRNS pending state determination component 230 (in response to a request or otherwise) SRNS pending state start/end information 14. In an aspect, SRNS pending state start/end information 14 may be an indication as to whether UE 110 is in an SRNS pending state or not. In another aspect, SRNS pending state start/end information 14 may be information that can be used by SRNS pending state determination component 230 to make such a determination by, for example, performing an algorithm on the information, applying a function to the information, or otherwise. In an aspect, to determine when the UE 110 is no longer in an SRNS pending state, SRNS pending state determination component 230 may continually request and/or receive notifications (e.g., SRNS pending state start/end information 14) from SRNS relocation component 116 to determine if the UE 110 is still in an SRNS pending state.

If SRNS pending state determination component 230 determines that UE 110 is not in an SRNS pending state, SRNS pending state determination component 230 may be configured to activate, or otherwise designate, non-SRNS pending state FRESH value management component 250 to perform an integrity check on received DL messages 17 by sending, for example, non-SRNS pending state information 20 to non-SRNS pending state FRESH value management component 250.

Non-SRNS pending state FRESH value management component 250 may be configured to communicate with FRESH value data store 210 to retrieve a current FRESH value 12. In an aspect, current FRESH value 12 may be the same as old FRESH value 11 since no SRNS RELOCATION message has been received with a new FRESH value because UE 110 is not currently in an SRNS pending state. Non-SRNS pending state FRESH value management component 250 may include current FRESH value comparison module 252, which may be configured to receive the retrieved current FRESH value 12 and apply the current FRESH value 12 to validate the received DL messages 17. If the applied current FRESH value 12 is a match for a FRESH value associated with the DL message 17, the DL message 17 is determined to be valid and non-SRNS pending state FRESH value management component 250 outputs a valid validation result 13.

If SRNS pending state determination component 230 determines that UE 110 is in an SRNS pending state, SRNS pending state determination component 230 may be configured to activate, or otherwise designate, SRNS pending state FRESH value management component 240 to perform an integrity check on received DL messages 17 by sending, for example, SRNS pending state information 21 to SRNS pending state FRESH value management component 240. SRNS pending state FRESH value management component 240 may be configured to communicate with FRESH value data store 210 to retrieve an old FRESH value 11 (e.g., a FRESH value received and used before the present SRNS RELOCATION message 18 was received by UE 110) and a new FRESH value 10 (e.g., a FRESH value received by UE 110 as part of the present SRNS RELOCATION message 18). SRNS pending state FRESH value management component 240 may be configured to apply both the old FRESH value and the new FRESH value to received DL messages 17. SRNS pending state FRESH value management component 240 includes new FRESH value comparison module 242 and old FRESH value comparison module 244, which may be configured to apply new FRESH value 10 and/or old FRESH value 11 to DL messages 17, respectively. If either new FRESH value comparison module 242 or old FRESH value comparison module 244 determines a match for a FRESH value associated the DL message 17, the DL message 17 may be determined to be valid and new FRESH value comparison module 242 and/or old FRESH value comparison module 244 may output a validation result 13, which may be further provided by SRNS pending state FRESH value management component 240 for use by other components within (and/or outside) UE 110.

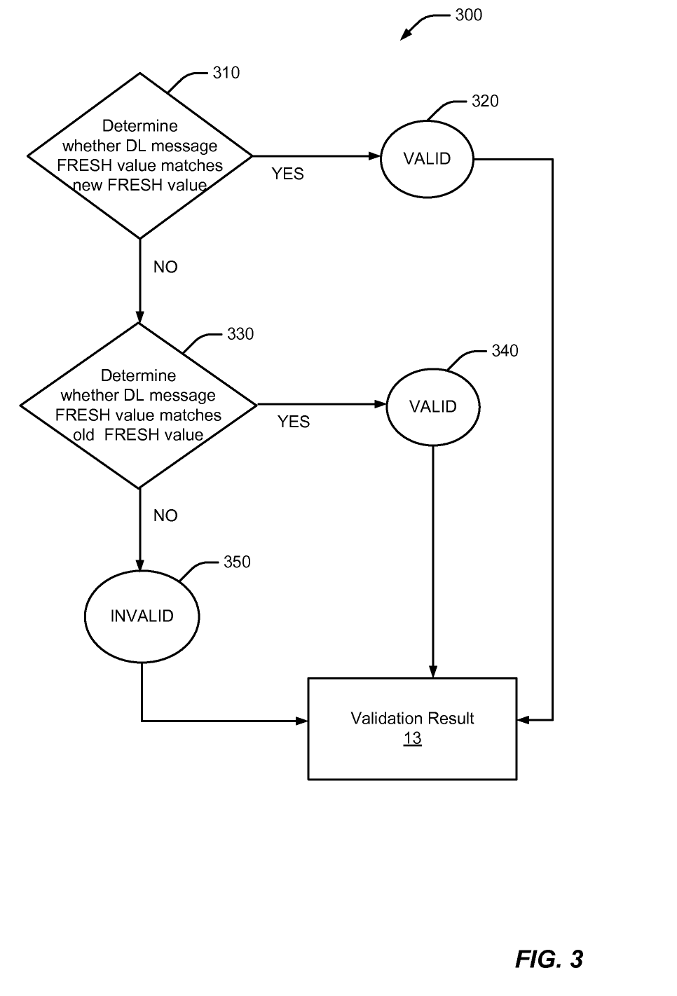

Referring to FIG. 3, a method 300 provides a more detailed aspect of integrity checking messages based on applying both an old FRESH value 11 and a new FRESH value 10. Although method 300 is described with respect to integrity checking DL messages 17 by UE 110 (and its components), it may be understood that the aspects described herein may be applied to integrity checking other messages (e.g., UL messages 22) at a UE, Node B, or some other network entity.

Aspects of method 300 may be performed by SRNS pending state FRESH value management component 240, of FIG. 2, within integrity protection component 114, of FIGS. 1 and 2, in communication with at least FRESH value data store 210 and SRNS pending state determination component 230, both of FIG. 2.

As described herein with respect to FIG. 2, SRNS pending state FRESH value management component 240 may be activated, or otherwise determine to perform an integrity check on DL messages 17 by SRNS pending state determination component 230. SRNS pending state FRESH value management component 240 also may be configured to retrieve an old FRESH value 11 and new FRESH value 10 from FRESH value data store 210.

At 310, the method 300 includes determining whether a DL message FRESH value matches a new FRESH value. For example, new FRESH value comparison module 242 may be configured to receive new FRESH value 10 and DL messages 17, determine a FRESH value associated with each DL message 17, and compare the FRESH value associated with a DL message 17 to the new FRESH value 10.

At 320, and if the new FRESH value comparison module 242 determines that there is a match between new FRESH value 10 and the FRESH value associated with the DL message 17, the SRNS pending state FRESH value management component 240 and/or new FRESH value comparison component 242 may determine that the DL message 17 is valid.

At 330, and if the new FRESH value comparison module 242 determines that there is not a match between new FRESH value 10 and the FRESH value associated with the DL message 17, the method 300 includes determining whether a DL message FRESH value matches an old FRESH value. For example, and in an aspect, upon determining that there is not a match between new FRESH value 10 and the FRESH value associated with DL message 17, the new FRESH value comparison module 242 may communicate the DL message 17 and/or FRESH value associated with the DL message 17 to old FRESH value comparison module 244. In another aspect, upon determining that there is not a match between new FRESH value 10 and the FRESH value associated with DL message 17, new FRESH value comparison module 242 and/or SRNS pending state FRESH value management component 240 may activate, or otherwise initiate old FRESH value comparison module 244 to compare the FRESH value associated with DL message 17 to old FRESH value 11. In another aspect, old FRESH value comparison module 244 may retrieve old FRESH value 11 from FRESH value data store 210 and may receive DL message 17 and/or the FRESH value associated with DL message 17, directly from SRNS pending state FRESH value management component 240, Node B 122, or otherwise.

At 340, and if the old FRESH value comparison module 244 determines that there is a match between old FRESH value 11 and the FRESH value associated with the DL message 17, the SRNS pending state FRESH value management component 240 and/or old FRESH value comparison module 244 may determine that the DL message 17 is valid.

At 350, and if the old FRESH value comparison module 244 determines that there is not a match between old FRESH value 11 and the FRESH value associated with the DL message 17, the SRNS pending state FRESH value management component 240 and/or old FRESH value comparison module 244 may determine that the DL message 17 is invalid.

In any case, SRNS pending state FRESH value management component 240, new FRESH value comparison module 242, and/or old FRESH value comparison module 244, may be configured to output a determination as to whether DL message 17 is valid as validation result 13.

Referring to FIG. 4, UE 110 includes RRC layer 112, as shown in FIG. 1. RRC layer 112 includes integrity protection component 114, SRNS relocation component 116, and message holding component 117, as shown in FIG. 1. Message holding component 117 may be configured to hold messages during an SRNS pending state to avoid message drops. Message holding component 117 may be in communication with SRNS pending state determination component 230 (within integrity protection component 114, which is not shown in FIG. 4, for simplicity), which itself is in communication with SRNS relocation component 116. UE 110 also includes NAS layer 410, which is a higher layer than RRC layer 112. As described herein, UE 110 may be in communication with the network via Node B 122 and/or Node B 132 to receive DL messages 17 (e.g., DL SRB 3/4 messages 15) and send UL messages 22 (e.g., UL SRB 3/4 response messages 16).

As described herein, SRNS pending state determination component 230, may be configured to receive and/or request a notification (e.g., SRNS pending state start/end information 14) from SRNS relocation component 116 to determine whether the UE 110 is in an SRNS pending state. In an aspect, SRNS pending state start/end information 14 may be an indication as to whether UE 110 is in an SRNS pending state or not. In another aspect, SRNS pending state start/end information 14 may be information that can be used by SRNS pending state determination component 230 to make such a determination by, for example, performing an algorithm on the information, applying a function to the information, or otherwise. In an aspect, to determine when the UE 110 is no longer in an SRNS pending state, SRNS pending state determination component 230 may continually request and/or receive notifications (e.g., SRNS pending state start/end information 14) from SRNS relocation component 116.

If SRNS pending state determination component 230 determines that UE 110 is in an SRNS pending state, SRNS pending state determination component 230 may activate, or otherwise so inform message holding component 117 by sending, for example, SRNS pending state information 21. Based on receiving SRNS pending state information 21, message holding component 117 may be configured to intercept, or otherwise identify, DL messages 17 received at the UE 110 from Node B 122, which are destined for a higher layer, e.g., NAS layer 410. DL messages 17 received by UE 110 via Node B 122 may be, in an aspect, DL SRB 3/4 messages 15. Message holding component 117 may receive DL SRB 3/4 messages 15 (and/or a copy thereof) directly from Node B 122 via, for example, communication component 440, or otherwise. In an aspect, message holding component 117 may be configured to store such DL SRB 3/4 messages 15 at message holding buffer 420. Message holding component 117 may receive non-SRNS pending state information 20 from SRNS pending state determination component 230 to indicate that the SRNS relocation procedure is complete and the UE 110 is no longer in an SRNS pending state. Based on receiving non-SRNS pending state information 20, message holding component 117 may be configured to retrieve the previously-held DL SRB 3/4 messages 15 from message holding buffer 420, and send the DL SRB 3/4 messages 15 to their destination (e.g., NAS layer 410) via communication component 440. By holding DL SRB 3/4 messages 15 during an SRNS pending state at message holding component 117, UE 110 helps assure that the DL SRB 3/4 messages 15 arrive safely at the NAS layer 410 and that any messages sent from the NAS layer in response arrive safely at RRC layer 112, and ultimately the network (e.g., RNC 130).

Similarly, message holding component 117 may be configured to intercept, or otherwise identify, UL SRB 3/4 response messages 16 scheduled by the NAS layer 410 for transmission to the network on the UL. UL messages 22 sent by UE 110 to Node B 132 may be, in an aspect, UL SRB 3/4 response messages 16. Such UL SRB 3/4 response messages 16 may be, for example, response messages to DL messages 17 and/or DL SRB 3/4 messages 15 received at UE 110 (e.g., at the NAS layer 410). Message holding component 117 may receive UL SRB 3/4 response messages 16 (and/or a copy thereof) from NAS layer 410 via, for example, communication component 440, or otherwise. In an aspect, message holding component 117 may be configured to store UL SRB 3/4 response messages 16 in message holding buffer 420. Message holding component 117 may receive non-SRNS pending state information 20 from SRNS pending state determination component 230 to indicate that the UE 110 is no longer in an SRNS pending state. Based on receiving non-SRNS pending state information 20, message holding component 117 may be configured to retrieve the previously-held UL SRB 3/4 response messages 16 from message holding buffer 420, and send the UL SRB 3/4 response messages 16 to their destination (e.g., the network via Node B 132) via communication component 440. By holding UL SRB 3/4 response messages 16 during an SRNS pending state, UE 110 at message holding component 117 helps assure that the UL SRB 3/4 response messages 16 are sent to the network and received by the proper Node B (e.g., Node B 132), upon completion of the RNC handover from the first RNC 120 to the second RNC 130.

Additional aspects of an example radio protocol architecture, including various layers, that may be included within UE 110, are described in more detail herein with respect to FIG. 10.

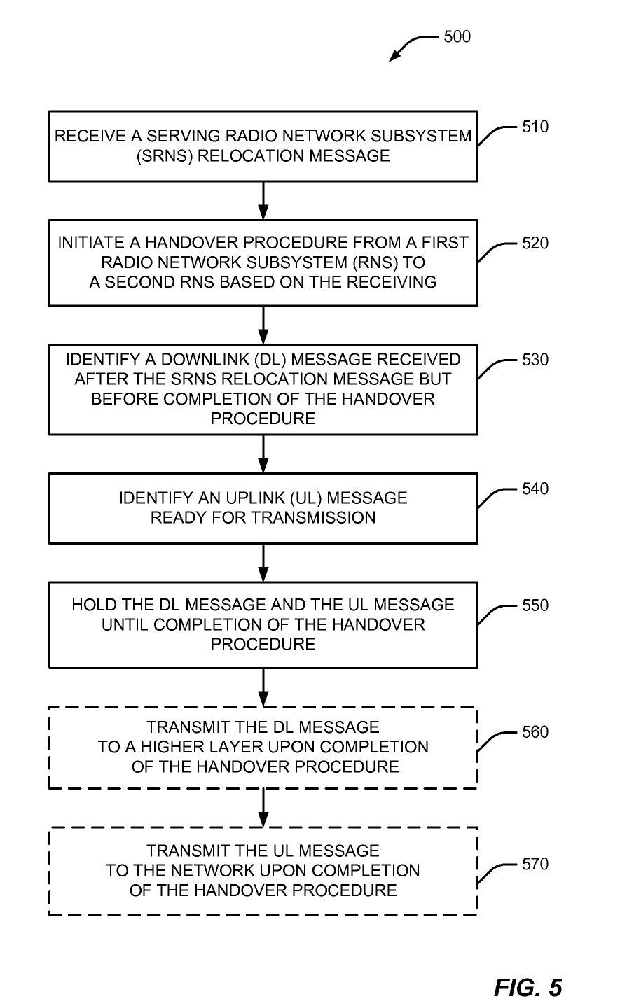

Referring to FIG. 5, a method 500 for wireless communication provides for holding DL messages and UL response messages during a Serving Radio Network Subsystem (SRNS) pending state to avoid message drops, and, as such, dropped calls. Aspects of method 500 may be performed by components within UE 110, such as, for example, integrity protection component 114, SRNS relocation component 116, and/or message holding component 117, as described herein with respect to FIGS. 1-4.

At 510, the method 500 includes receiving a Serving Radio Network Subsystem (SRNS) RELOCATION message. UE 110 and/or SRNS relocation component 116 may receive an SRNS RELOCATION message 18 from a currently-serving Node B (e.g., Node B 122 associated with a first RNC 120). The SRNS RELOCATION message 18 may include a new FRESH value 10 received by Node B 122 from Node B 132, which is associated with a second RNC 130.

At 520, the method 500 includes initiating a handover procedure from a first radio network subsystem (RNS) to a second RNS based on the receiving. Upon receipt of the SRNS RELOCATION message 18 from Node B 122, which is associated with a first RNC 120, UE 110 may begin an SRNS relocation procedure from RNC 120 to RNC 130 and enter an SRNS pending state. Upon completion of the SRNS relocation procedure, and exit from the SRNS pending state (which may be determined by SRNS relocation component 116 and shared with other components within UE 110 via SRNS pending state start/end information 14), UE 110 may be served by Node B 132 associated with the second RNC 130. In an aspect, SRNS relocation component 116 may be configured to handle the SRNS relocation procedure and send an SRNS RELOCATION COMPLETE message 19 to the network.

At 530, the method 500 includes identifying a downlink (DL) message received after the SRNS RELOCATION message but before completion of the handover procedure. In some instances, despite having sent an SRNS RELOCATION message 18 to UE 110, the network (e.g., Node B 122) may continue to send DL messages 17 to UE 110 before completion of the SRNS relocation procedure. In an aspect, the DL message may be DL SRB 3/4 messages 15. Such DL messages 17 may have been sent, or scheduled to be sent, by Node B 122 before the SRNS RELOCATION message 18 was sent to, or meant to be received by, UE 110; however, the DL message 17 was delayed for some reason, and, as such, reached the UE 110 after the SRNS RELOCATION message 18. In an aspect, the DL message 17 may be integrity protected by a FRESH value (e.g., an old FRESH value 11) associated with the UE 110 from before the SRNS RELOCATION message 18 (having a new FRESH value 10), was sent. Message holding component 117 may be configured to intercept and/or identify such DL messages 17, as described herein.

At 540, the method 500 includes identifying an uplink (UL) message ready for transmission. A response to the DL message 17, which may be a UL message 22 may not be ready for transmission to the network until after the SRNS RELOCATION message 18 has been received and the UE 110 is in an SRNS pending state. In an aspect, UL message 22 may be UL SRB 3/4 response messages 16, generated by NAS layer 410 of FIG. 4. Message holding component 117 may be configured to intercept and/or identify such UL messages 22 as described herein.

At 540, the method 500 includes holding the DL message and the UL message until completion of the handover procedure. Message holding component 117 may be configured to hold, in message holding buffer 320, DL messages 17 (e.g., DL SRB 3/4 messages 15) and/or UL messages 22 (e.g., UL SRB 3/4 response messages 16) until the UE 110 exits the SRNS pending state (as determined by SRNS pending state determination component 230, and communicated to message holding component 117 via non-SRNS pending state information 20) and the SRNS handover procedure is complete, such that UE 110 is now being served by Node B 132 associated with the second RNC 130, as described herein.

At 560, the method 500 may optionally include transmitting the DL message to a higher layer upon completion of the handover procedure. Upon receipt of the non-SRNS pending state information 20 from SRNS pending state determination component 230, message holding component 117 may be configured to retrieve any held DL SRB 3/4 messages 15 from message holding buffer 420, and transmit the previously-held DL SRB 3/4 messages 15 to NAS layer 410 via communication component 440.

At 570, the method 500 may optionally include transmitting the UL message to the network upon completion of the handover procedure. Upon receipt of the non-SRNS pending state information 20 from SRNS pending state determination component 230, message holding component 117 may be configured to retrieve any held UL SRB 3/4 response messages 16 from message holding buffer 420, and transmit the previously-held UL SRB 3/4 response messages 16 to the network, e.g., Node B 132 of the second RNC 130, via communication component 440.

In an aspect (not shown), method 500 also may include receiving the Serving Radio Network Subsystem (SRNS) RELOCATION message 18, wherein the SRNS RELOCATION message 18 includes a new FRESH value 10, retaining an old FRESH value 11 determined before the receiving, and applying both the old FRESH value 11 and new FRESH value 10 to the DL message 17 to determine if the DL message 17 is valid. Such aspects may be performed by integrity protection component 114 in communication with SRNS relocation component 116.

The method 500 is shown and described as a series of acts, it is to be understood and appreciated that the methodologies are not limited by the order of acts, as some acts may, in accordance with one or more aspects, occur in different orders and/or concurrently with other acts from that shown and described herein. For example, it is to be appreciated that a methodology could alternatively be represented as a series of interrelated states or events, such as in a state diagram. Moreover, not all illustrated acts may be required to implement a methodology in accordance with one or more aspects.

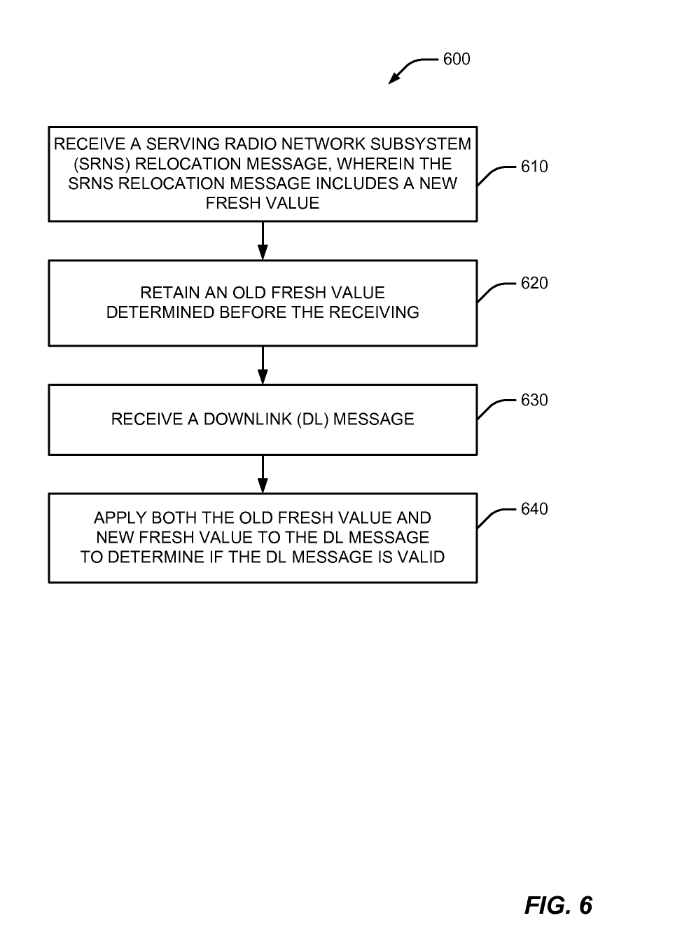

Referring to FIG. 6, a method 600 for wireless communication provides for applying both an old FRESH value 11 and a new FRESH value 10 to determine whether a received DL message 17 is valid. Aspects of method 600 may be performed by components within UE 110, such as, for example, integrity protection component 114, SRNS relocation component 116, and/or message holding component 117, as described herein with respect to FIGS. 1-4.

At 610, the method 600 includes receiving a Serving Radio Network Subsystem (SRNS) RELOCATION message, wherein the SRNS RELOCATION message includes a new FRESH value. UE 110 and/or SRNS relocation component 116 may receive an SRNS RELOCATION message 18 from a currently-serving Node B (e.g., Node B 122, which is associated with a first RNC 120). The SRNS RELOCATION message 18 may include a new FRESH value 10. The SRNS relocation component 116 may be configured to notify integrity protection component 114 that the UE 110 is in an SRNS pending state via SRNS pending state start/end information 14. The SRNS relocation component 116 also may be configured to provide the new FRESH value 10 to integrity protection component 114. The new FRESH value 10 may be associated with a second RNC 130 to which UE 110 is relocating. The new FRESH value 10 may be provided to Node B 122 (e.g., a currently serving Node B), for transmission to the UE 110 within SRNS RELOCATION message 18, by Node B 132 (e.g., a target Node B).

At 620, the method 600 includes retaining an old FRESH value determined before the receiving. Integrity protection component 114 may be configured to retain an old FRESH value 11 (e.g., a current FRESH value 12 being used before receipt of the present SRNS RELOCATION message 18) until completion of the SRNS relocation procedure. More particularly, once integrity protection component 114, via SRNS pending state determination component 230, determines that the UE 110 is in an SRNS pending state, integrity protection component 114 may be configured to hold, and store (e.g., in FRESH value data store 210), any existing FRESH values (e.g., old FRESH value 11 and/or current FRESH value 12). Integrity protection component 114 also may be configured to receive a new FRESH value 10 from SRNS relocation component 116 and, similarly, store the new FRESH value 10 in FRESH value data store 210.

At 630, the method 600 includes receiving a downlink (DL) message. The DL message 17 may be received by UE 110 from a currently-serving Node B (e.g., Node B 122). In some instances, despite having sent an SRNS RELOCATION message 18 to UE 110, the network (e.g., Node B 122) may continue to send DL messages 17 to UE 110. Such DL messages 17 may have been sent, or scheduled to be sent, by Node B 122 before the SRNS RELOCATION message 18 was sent to, or meant to be received by, UE 110; however, the DL message 17 was delayed for some reason, and, as such, reached the UE 110 after the SRNS RELOCATION message 18. In an aspect, the DL message 17 may be integrity protected by a FRESH value (e.g., an old FRESH value 11) associated with the UE 110 from before the SRNS RELOCATION message 18 (which included the new FRESH value 10), was sent to UE 110.

At 640, the method 600 includes applying both the old FRESH value and new FRESH value to the DL message to determine if the DL message is valid. Integrity protection component 114, via SRNS pending state FRESH value management component 240, may be configured to validate the DL message 17 by applying both the new FRESH value 10 to the DL message 17 (via new FRESH value comparison module 242) and the old FRESH value 11 (via old FRESH value comparison module 244). If either FRESH value is a match for the FRESH value associated with the DL message 17, the DL message 17 is determined to be valid and SRNS pending state FRESH value management component 240 and/or integrity protection component 114 may be configured to output a validation result 13.

In an aspect (not shown), the method 600 also may include initiating a handover procedure from a first radio network subsystem (RNS) to a second RNS based on receiving the SRNS RELOCATION message 18, identifying a downlink (DL) message 17 received after the SRNS RELOCATION message 18 but before completion of the handover procedure, identifying an uplink (UL) message 22 ready for transmission, and holding the DL message 17 and the UL message 22 until completion of the handover procedure. Such aspects may be performed by message holding component 117 in communication with SRNS pending state determination component 230. In an aspect, DL message 17 may be DL SRB 3/4 messages 15 and UL message 22 may be UL SRB 3/4 response messages 16.

The method 600 is shown and described as a series of acts, it is to be understood and appreciated that the methodologies are not limited by the order of acts, as some acts may, in accordance with one or more aspects, occur in different orders and/or concurrently with other acts from that shown and described herein. For example, it is to be appreciated that a methodology could alternatively be represented as a series of interrelated states or events, such as in a state diagram. Moreover, not all illustrated acts may be required to implement a methodology in accordance with one or more aspects.

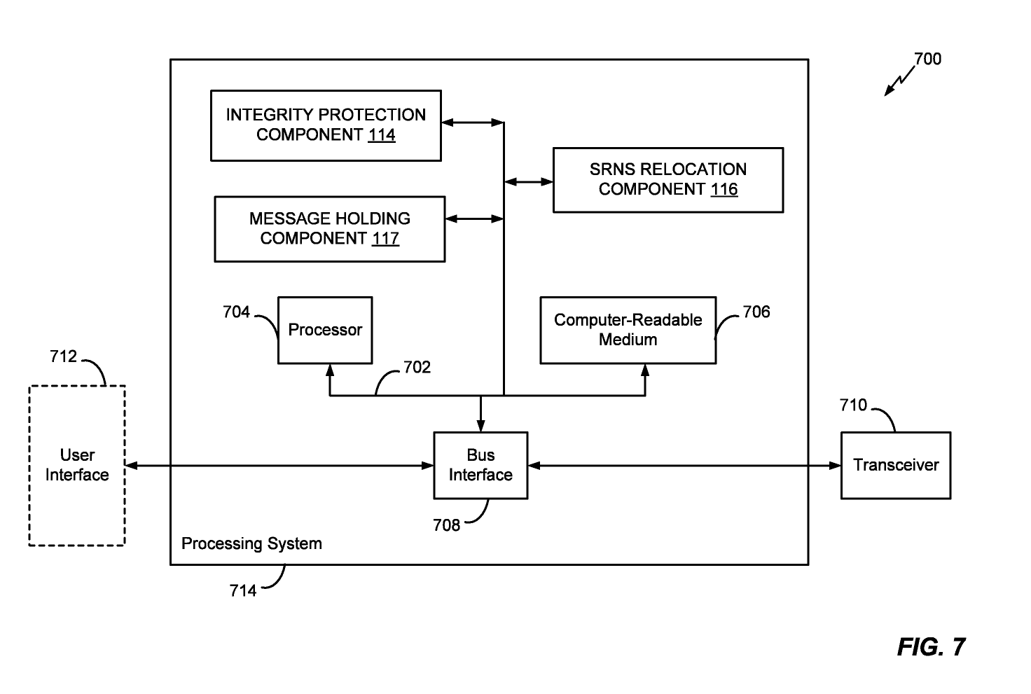

FIG. 7 is a block diagram illustrating an example of a hardware implementation for an apparatus 700 employing a processing system 714. In an aspect, apparatus 700 may be UE 110 of FIG. 1, including integrity protection component 114, SRNS relocation component 116, and message holding component 117. In this example, the processing system 714 may be implemented with a bus architecture, represented generally by the bus 702. The bus 702 may include any number of interconnecting buses and bridges depending on the specific application of the processing system 714 and the overall design constraints. The bus 702 links together various circuits including one or more processors, represented generally by the processor 704, one or more communications components, such as, for example, communication component 440 of FIG. 4, integrity protection component 114, SRNS relocation component 116, message holding component 117, and computer-readable media, represented generally by the computer-readable medium 706. The bus 702 may also link various other circuits such as timing sources, peripherals, voltage regulators, and power management circuits, which are well known in the art, and therefore, will not be described any further. A bus interface 708 provides an interface between the bus 702 and a transceiver 710. The transceiver 710 provides a means for communicating with various other apparatus over a transmission medium. Depending upon the nature of the apparatus, a user interface 712 (e.g., keypad, display, speaker, microphone, joystick) may also be provided.

The processor 704 is responsible for managing the bus 702 and general processing, including the execution of software stored on the computer-readable medium 706. The software, when executed by the processor 704, causes the processing system 714 to perform the various functions described herein for any particular apparatus or component, including, for example, integrity protection component 114, SRNS relocation component 116, message holding component 117, and/or components therewithin. The computer-readable medium 706 may also be used for storing data that is manipulated by the processor 704 when executing software associated with the various functions described herein for any particular apparatus or component including, for example, integrity protection component 114, SRNS relocation component 116, message holding component 117, and/or components therewithin.

The various concepts presented throughout this disclosure may be implemented across a broad variety of telecommunication systems, network architectures, and communication standards. By way of example and without limitation, the aspects of the present disclosure illustrated in FIG. 8 are presented with reference to a UMTS system 800 employing a W-CDMA and/or TD-SCDMA air interface. A UMTS network includes three interacting domains: a Core Network (CN) 804, a UMTS Terrestrial Radio Access Network (UTRAN) 802, and User Equipment (UE) 810. In an aspect, UE 810 may be UE 110 of FIG. 1. In this example, the UTRAN 802 provides various wireless services including telephony, video, data, messaging, broadcasts, and/or other services. The UTRAN 802 may include a plurality of Radio Network Subsystems (RNSs) such as an RNS 807, each controlled by a respective Radio Network Controller (RNC) such as an RNC 806. Here, the UTRAN 802 may include any number of RNCs 806 and RNSs 807 in addition to the RNCs 806 and RNSs 807 illustrated herein. The RNC 806 is an apparatus responsible for, among other things, assigning, reconfiguring and releasing radio resources within the RNS 807. The RNC 806 may be interconnected to other RNCs (not shown) in the UTRAN 802 through various types of interfaces such as a direct physical connection, a virtual network, or the like, using any suitable transport network.

Communication between a UE 810 and a Node B 808 may be considered as including a physical (PHY) layer and a medium access control (MAC) layer. Further, communication between a UE 810 and an RNC 806 by way of a respective Node B 808 may be considered as including a radio resource control (RRC) layer. In the instant specification, the PHY layer may be considered layer 1; the MAC layer may be considered layer 2; and the RRC layer may be considered layer 3. Information herein below utilizes terminology introduced in the RRC Protocol Specification, 3GPP TS 25.331 v9.1.0, incorporated herein by reference.

The geographic region covered by the RNS 807 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. In an aspect, and for example, Node B 808 may be Node B 122 and/or Node B 132 of FIG. 1. For clarity, three Node Bs 808 are shown in each RNS 807; however, the RNSs 807 may include any number of wireless Node Bs. The Node Bs 808 provide wireless access points to a CN 804 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as a UE in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In a UMTS system, the UE 810 may further include a universal subscriber identity module (USIM) 811, which contains a user's subscription information to a network. For illustrative purposes, one UE 810 is shown in communication with a number of the Node Bs 808. The DL, also called the forward link, refers to the communication link from a Node B 808 to a UE 810, and the UL, also called the reverse link, refers to the communication link from a UE 810 to a Node B 808.

The CN 804 interfaces with one or more access networks, such as the UTRAN 802. As shown, the CN 804 is a GSM core network. However, as those skilled in the art will recognize, the various concepts presented throughout this disclosure may be implemented in a RAN, or other suitable access network, to provide UEs with access to types of CNs other than GSM networks.

The CN 804 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 804 supports circuit-switched services with a MSC 812 and a GMSC 814. In some applications, the GMSC 814 may be referred to as a media gateway (MGW). One or more RNCs, such as the RNC 806, may be connected to the MSC 812. The MSC 812 is an apparatus that controls call setup, call routing, and UE mobility functions. The MSC 812 also includes a VLR that contains subscriber-related information for the duration that a UE is in the coverage area of the MSC 812. The GMSC 814 provides a gateway through the MSC 812 for the UE to access a circuit-switched network 816. The GMSC 814 includes a home location register (HLR) 815 containing subscriber data, such as the data reflecting the details of the services to which a particular user has subscribed. The HLR is also associated with an authentication center (AuC) that contains subscriber-specific authentication data. When a call is received for a particular UE, the GMSC 814 queries the HLR 815 to determine the UE's location and forwards the call to the particular MSC serving that location.

The CN 804 also supports packet-data services with a serving GPRS support node (SGSN) 818 and a gateway GPRS support node (GGSN) 820. GPRS, which stands for General Packet Radio Service, is designed to provide packet-data services at speeds higher than those available with standard circuit-switched data services. The GGSN 820 provides a connection for the UTRAN 802 to a packet-based network 822. The packet-based network 822 may be the Internet, a private data network, or some other suitable packet-based network. The primary function of the GGSN 820 is to provide the UEs 810 with packet-based network connectivity. Data packets may be transferred between the GGSN 820 and the UEs 810 through the SGSN 818, which performs primarily the same functions in the packet-based domain as the MSC 812 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a Node B 808 and a UE 810. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

An HSPA air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

HSDPA utilizes as its transport channel the high-speed downlink shared channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries the HARQ ACK/NACK signaling on the uplink to indicate whether a corresponding packet transmission was decoded successfully. That is, with respect to the downlink, the UE 810 provides feedback to the Node B 808 over the HS-DPCCH to indicate whether it correctly decoded a packet on the downlink.

HS-DPCCH further includes feedback signaling from the UE 810 to assist the Node B 808 in taking the right decision in terms of modulation and coding scheme and precoding weight selection, this feedback signaling including the CQI and PCI.

“HSPA Evolved” or HSPA+ is an evolution of the HSPA standard that includes MIMO and 64-QAM, enabling increased throughput and higher performance. That is, in an aspect of the disclosure, the Node B 808 and/or the UE 810 may have multiple antennas supporting MIMO technology. The use of MIMO technology enables the Node B 808 to exploit the spatial domain to support spatial multiplexing, beamforming, and transmit diversity.

Multiple Input Multiple Output (MIMO) is a term generally used to refer to multi-antenna technology, that is, multiple transmit antennas (multiple inputs to the channel) and multiple receive antennas (multiple outputs from the channel). MIMO systems generally enhance data transmission performance, enabling diversity gains to reduce multipath fading and increase transmission quality, and spatial multiplexing gains to increase data throughput.

Spatial multiplexing may be used to transmit different streams of data simultaneously on the same frequency. The data steams may be transmitted to a single UE 810 to increase the data rate or to multiple UEs 810 to increase the overall system capacity. This is achieved by spatially precoding each data stream and then transmitting each spatially precoded stream through a different transmit antenna on the downlink. The spatially precoded data streams arrive at the UE(s) 810 with different spatial signatures, which enables each of the UE(s) 810 to recover the one or more the data streams destined for that UE 810. On the uplink, each UE 810 may transmit one or more spatially precoded data streams, which enables the Node B 808 to identify the source of each spatially precoded data stream.

Spatial multiplexing may be used when channel conditions are good. When channel conditions are less favorable, beamforming may be used to focus the transmission energy in one or more directions, or to improve transmission based on characteristics of the channel. This may be achieved by spatially precoding a data stream for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport blocks sent over the n transmit antennas may have the same or different modulation and coding schemes from one another.

On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

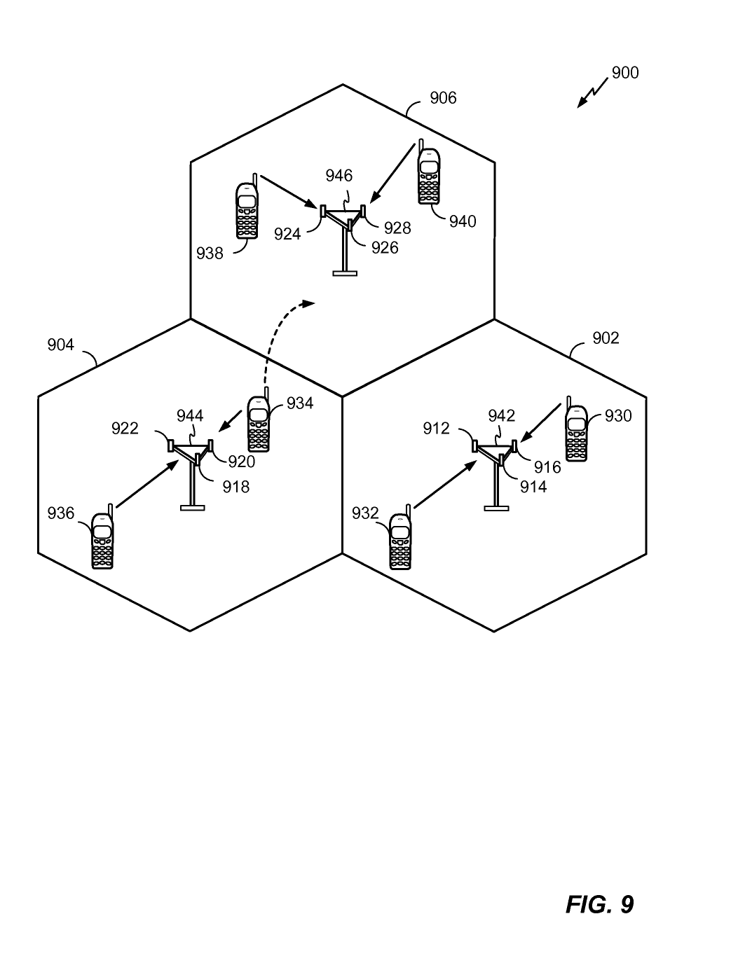

Referring to FIG. 9, an access network 900 in a UTRAN architecture is illustrated. The multiple access wireless communication system includes multiple cellular regions (cells), including cells 902, 904, and 906, each of which may include one or more sectors. In an aspect, one of cells 902, 904, and 906 may be Node B 808 of FIG. 8, Node B 122 and/or Node B 132, both of FIG. 1. The multiple sectors can be formed by groups of antennas with each antenna responsible for communication with UEs in a portion of the cell. For example, in cell 902, antenna groups 912, 914, and 916 may each correspond to a different sector. In cell 904, antenna groups 918, 920, and 922 each correspond to a different sector. In cell 906, antenna groups 924, 926, and 928 each correspond to a different sector. The cells 902, 904 and 906 may include several wireless communication devices, e.g., User Equipment or UEs, which may be in communication with one or more sectors of each cell 902, 904 or 906. For example, UEs 930 and 932 may be in communication with Node B 942, UEs 934 and 936 may be in communication with Node B 944, and UEs 938 and 940 can be in communication with Node B 946. In an aspect, one of UEs 930, 932, 934, 936, 938, and/or 940 may be UE 810 of FIG. 8 and/or UE 110 of FIG. 1. Here, each Node B 942, 944, 946 is configured to provide an access point to a CN 804 (see FIG. 8) for all the UEs 930, 932, 934, 936, 938, 940 in the respective cells 902, 904, and 906.

As the UE 934 moves from the illustrated location in cell 904 into cell 906, a serving cell change (SCC) or handover may occur in which communication with the UE 934 transitions from the cell 904, which may be referred to as the source cell, to cell 906, which may be referred to as the target cell. Management of the handover procedure may take place at the UE 934, at the Node Bs corresponding to the respective cells, at a radio network controller 806 (see FIG. 8), or at another suitable node in the wireless network. For example, during a call with the source cell 904, or at any other time, the UE 934 may monitor various parameters of the source cell 904 as well as various parameters of neighboring cells such as cells 906 and 902. Further, depending on the quality of these parameters, the UE 934 may maintain communication with one or more of the neighboring cells. During this time, the UE 934 may maintain an Active Set, that is, a list of cells that the UE 934 is simultaneously connected to (i.e., the UTRA cells that are currently assigning a downlink dedicated physical channel DPCH or fractional downlink dedicated physical channel F-DPCH to the UE 934 may constitute the Active Set).

The modulation and multiple access scheme employed by the access network 900 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The radio protocol architecture may take on various forms depending on the particular application. An example for an HSPA system will now be presented with reference to FIG. 10.

Referring to FIG. 10 an example radio protocol architecture 1000 relates to the user plane 1002 and the control plane 1004 of a user equipment (UE) or Node B/base station. In an aspect, architecture 1000 may be included in a UE such as UE 110 of FIG. 1. In an aspect, architecture 1000 may be included in a base station, such as Node B 122 and/or Node B 132 of FIG. 1. The radio protocol architecture 1000 for the UE and Node B is shown with three layers: Layer 1 1006, Layer 2 1008, and Layer 3 1010. Layer 1 1006 is the lowest lower and implements various physical layer signal processing functions. As such, Layer 1 1006 includes the physical layer 1012. Layer 2 (L2 layer) 1008 is above the physical layer 1012 and is responsible for the link between the UE and Node B over the physical layer 1012. Layer 3 (L3 layer) 1010 includes a radio resource control (RRC) sublayer 1020. In an aspect, RRC sublayer 1020 may be RRC layer 112, of FIGS. 1-3. The RRC sublayer 1020 handles the control plane signaling of Layer 3 between the UE and the UTRAN.

In the user plane, the L2 layer 1008 includes a media access control (MAC) sublayer 1014, a radio link control (RLC) sublayer 1016, and a packet data convergence protocol (PDCP) 1018 sublayer, which are terminated at the Node B on the network side. Although not shown, the UE may have several upper layers above the L2 layer 1008 including a network layer (e.g., IP layer) that is terminated at a PDN gateway on the network side, and an application layer that is terminated at the other end of the connection (e.g., far end UE, server, etc.).

The PDCP sublayer 1018 provides multiplexing between different radio bearers and logical channels. The PDCP sublayer 1018 also provides header compression for upper layer data packets to reduce radio transmission overhead, security by ciphering the data packets, and handover support for UEs between Node Bs. The RLC sublayer 1016 provides segmentation and reassembly of upper layer data packets, retransmission of lost data packets, and reordering of data packets to compensate for out-of-order reception due to hybrid automatic repeat request (HARQ). The MAC sublayer 1014 provides multiplexing between logical and transport channels. The MAC sublayer 1014 is also responsible for allocating the various radio resources (e.g., resource blocks) in one cell among the UEs. The MAC sublayer 1010 is also responsible for HARQ operations.

Architecture 1000 also may include (not shown) a Non-Access Stratum (NAS) layer above RRC sublayer 1020 (e.g., RRC layer 112) within layer 3 1010 of the architecture 1000. In an aspect, the NAS layer (not shown) may be NAS layer 410 of FIG. 4. The NAS layer is a functional layer in architecture 1000 between the core network (e.g., CN 804 described herein with respect to FIG. 8) and UE 110. The NAS layer manages the establishment of communication sessions and maintains continuous communications with the UE 110 as it moves. The NAS is defined in contrast to the Access Stratum, which includes the RRC sublayer 1020 (e.g., RRC layer 112), a RLC sublayer 1016, MAC sublayer 1014, and physical layer 1012. For purposes of this disclose, the terms layer and sublayer may be used interchangeably.

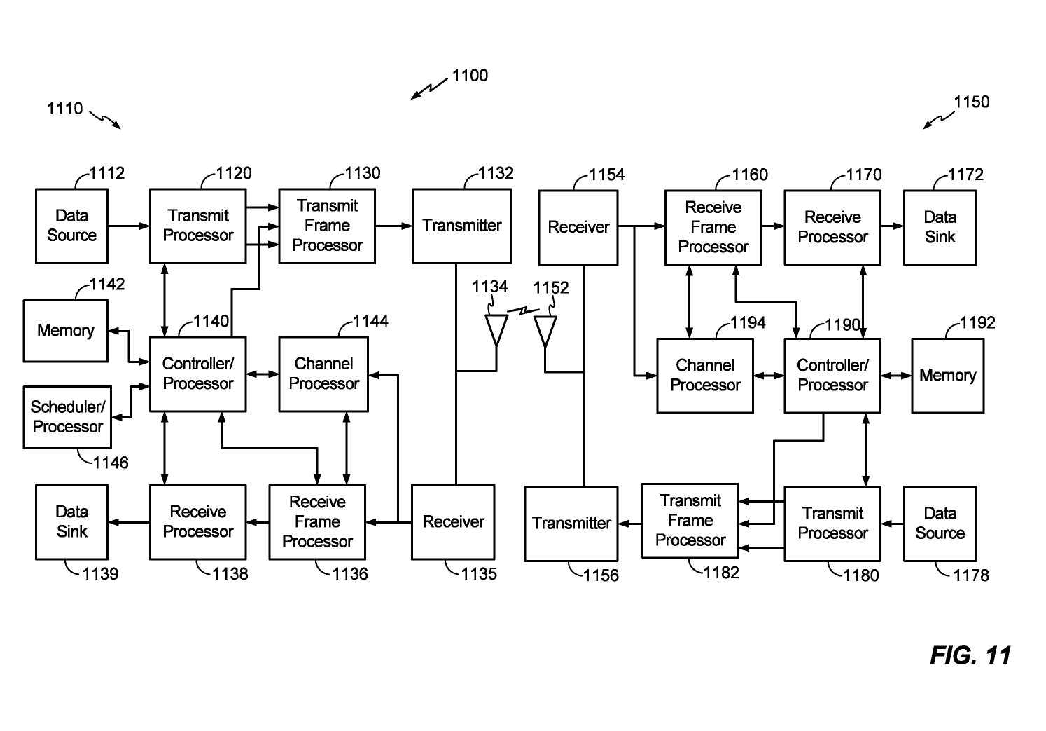

FIG. 11 is a block diagram of a Node B 1110 in communication with a UE 1150, where the Node B 1110 may be the Node B 808 in FIG. 8, and the UE 1150 may be the UE 1110 in FIG. 11. Further, in an aspect, UE 1150 may be UE 110 of FIG. 1 and Node B 1110 may be Node B 122 and/or Node B 132 of FIG. 1. In the downlink communication, a transmit processor 1120 may receive data from a data source 1112 and control signals from a controller/processor 1140. The transmit processor 1120 provides various signal processing functions for the data and control signals, as well as reference signals (e.g., pilot signals). For example, the transmit processor 1120 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 1144 may be used by a controller/processor 1140 to determine the coding, modulation, spreading, and/or scrambling schemes for the transmit processor 1120. These channel estimates may be derived from a reference signal transmitted by the UE 1150 or from feedback from the UE 1150. The symbols generated by the transmit processor 1120 are provided to a transmit frame processor 1130 to create a frame structure. The transmit frame processor 1130 creates this frame structure by multiplexing the symbols with information from the controller/processor 1140, resulting in a series of frames. The frames are then provided to a transmitter 1132, which provides various signal conditioning functions including amplifying, filtering, and modulating the frames onto a carrier for downlink transmission over the wireless medium through antenna 1134. The antenna 1134 may include one or more antennas, for example, including beam steering bidirectional adaptive antenna arrays or other similar beam technologies.

At the UE 1150, a receiver 1154 receives the downlink transmission through an antenna 1152 and processes the transmission to recover the information modulated onto the carrier. The information recovered by the receiver 1154 is provided to a receive frame processor 1160, which parses each frame, and provides information from the frames to a channel processor 1194 and the data, control, and reference signals to a receive processor 1170. The receive processor 1170 then performs the inverse of the processing performed by the transmit processor 1120 in the Node B 1110. More specifically, the receive processor 1170 descrambles and despreads the symbols, and then determines the most likely signal constellation points transmitted by the Node B 1110 based on the modulation scheme. These soft decisions may be based on channel estimates computed by the channel processor 1194. The soft decisions are then decoded and deinterleaved to recover the data, control, and reference signals. The CRC codes are then checked to determine whether the frames were successfully decoded. The data carried by the successfully decoded frames will then be provided to a data sink 1172, which represents applications running in the UE 1150 and/or various user interfaces (e.g., display). Control signals carried by successfully decoded frames will be provided to a controller/processor 1190. When frames are unsuccessfully decoded by the receiver processor 1170, the controller/processor 1190 may also use an acknowledgement (ACK) and/or negative acknowledgement (NACK) protocol to support retransmission requests for those frames.

In the uplink, data from a data source 1178 and control signals from the controller/processor 1190 are provided to a transmit processor 1180. The data source 1178 may represent applications running in the UE 1150 and various user interfaces (e.g., keyboard). Similar to the functionality described in connection with the downlink transmission by the Node B 1110, the transmit processor 1180 provides various signal processing functions including CRC codes, coding and interleaving to facilitate FEC, mapping to signal constellations, spreading with OVSFs, and scrambling to produce a series of symbols. Channel estimates, derived by the channel processor 1194 from a reference signal transmitted by the Node B 1110 or from feedback contained in the midamble transmitted by the Node B 1110, may be used to select the appropriate coding, modulation, spreading, and/or scrambling schemes. The symbols produced by the transmit processor 1180 will be provided to a transmit frame processor 1182 to create a frame structure. The transmit frame processor 1182 creates this frame structure by multiplexing the symbols with information from the controller/processor 1190, resulting in a series of frames. The frames are then provided to a transmitter 1156, which provides various signal conditioning functions including amplification, filtering, and modulating the frames onto a carrier for uplink transmission over the wireless medium through the antenna 1152.

The uplink transmission is processed at the Node B 1110 in a manner similar to that described in connection with the receiver function at the UE 1150. A receiver 1135 receives the uplink transmission through the antenna 1134 and processes the transmission to recover the information modulated onto the carrier. The information recovered by the receiver 1135 is provided to a receive frame processor 1136, which parses each frame, and provides information from the frames to the channel processor 1144 and the data, control, and reference signals to a receive processor 1138. The receive processor 1138 performs the inverse of the processing performed by the transmit processor 1180 in the UE 1150. The data and control signals carried by the successfully decoded frames may then be provided to a data sink 1139 and the controller/processor, respectively. If some of the frames were unsuccessfully decoded by the receive processor, the controller/processor 1140 may also use an acknowledgement (ACK) and/or negative acknowledgement (NACK) protocol to support retransmission requests for those frames.

The controller/processors 1140 and 1190 may be used to direct the operation at the Node B 1110 and the UE 1150, respectively. For example, the controller/processors 1140 and 1190 may provide various functions including timing, peripheral interfaces, voltage regulation, power management, and other control functions. The computer readable media of memories 1142 and 1192 may store data and software for the Node B 1110 and the UE 1150, respectively. A scheduler/processor 1146 at the Node B 1110 may be used to allocate resources to the UEs and schedule downlink and/or uplink transmissions for the UEs.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA, TD-SCDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA), TD-SCDMA and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM□, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques. Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method for wireless communication, comprising:
receiving a Serving Radio Network Subsystem (SRNS) RELOCATION message;
initiating a handover procedure from a first radio network subsystem (RNS) to a second RNS based on the SRNS RELOCATION message;
identifying a downlink (DL) message;
identifying an uplink (UL) message; and
holding the DL message and the UL message at a radio resource control (RRC) layer until completion of the handover procedure.

2. The method of claim 1, further comprising receiving the DL message after the SRNS RELOCATION message but before completion of the handover procedure.

3. The method of claim 1, further comprising receiving the DL message from the first RNS.

4. The method of claim 1, further comprising transmitting the DL message to a higher layer upon completion of the handover procedure.

5. The method of claim 1, further comprising:
generating, by a higher layer, the UL message in response to the DL message; and
scheduling, by the higher layer, the UL message for transmission to the network.

6. The method of claim 1, further comprising transmitting the UL message to the network upon completion of the handover procedure.

7. The method of claim 1, wherein the SRNS RELOCATION message includes a new FRESH value, and further comprising:
retaining an old FRESH value determined before the receiving; and
applying both the old FRESH value and new FRESH value to the DL message to determine if the DL message is valid.

8. A method for wireless communication, comprising:
receiving a Serving Radio Network Subsystem (SRNS) RELOCATION message, wherein the SRNS RELOCATION message includes a new FRESH value;
retaining an old FRESH value determined before the SRNS RELOCATION was received;
receiving a downlink (DL) message; and
applying both the old FRESH value and new FRESH value to the DL message to determine if the DL message is valid.

9. The method of claim 8, further comprising initiating a handover procedure from a first radio network subsystem (RNS) to a second RNS based on the receiving, and wherein the DL message is received from the first RNS after the SRNS RELOCATION message, but before completion of the handover.

10. The method of claim 9, wherein the new FRESH value is associated with the second RNS.

11. The method of claim 8, further comprising:
initiating a handover procedure from a first radio network subsystem (RNS) to a second RNS based on the SRNS RELOCATION message;
identifying the DL message, wherein the DL message was received after the SRNS RELOCATION message was received but before completion of the handover procedure;
identifying an uplink (UL) message, wherein the UL message is generated by a higher layer in response to the DL message and has been scheduled, by the higher layer, for transmission to the network; and
holding the DL message and the UL message until completion of the handover procedure.

12. The method of claim 11, wherein holding the DL message and the UL message comprises:
determining that the handover procedure has been completed;
retrieving the held DL message and UL message;
transmitting the retrieved DL message to a higher layer; and
transmitting the retrieved UL message to the network.

13. A computer program product comprising:
a computer readable medium comprising:
code for causing at least one computer to:
receive a Serving Radio Network Subsystem (SRNS) RELOCATION message;
initiate a handover procedure from a first radio network subsystem (RNS) to a second RNS based on the SRNS RELOCATION message;
identify a downlink (DL) message;
identify an uplink (UL) message; and
hold the DL message and the UL message at a radio resource control (RRC) layer until completion of the handover procedure.

14. A computer program product comprising:
a computer readable medium comprising:
code for causing at least one computer to:
receive a Serving Radio Network Subsystem (SRNS) RELOCATION message, wherein the SRNS RELOCATION message includes a new FRESH value;
retain an old FRESH value determined before the SRNS RELOCATION was received;
receive a downlink (DL) message; and
apply both the old FRESH value and new FRESH value to the DL message to determine if the DL message is valid.

15. An apparatus for wireless communication, comprising:
means for receiving a Serving Radio Network Subsystem (SRNS) RELOCATION message;
means for initiating a handover procedure from a first radio network subsystem (RNS) to a second RNS based on the SRNS RELOCATION message;
means for identifying a downlink (DL) message;
means for identifying an uplink (UL) message; and
means for holding the DL message and the UL message until completion of the handover procedure.

16. An apparatus for wireless communication, comprising:
means for receiving a Serving Radio Network Subsystem (SRNS) RELOCATION message, wherein the SRNS RELOCATION message includes a new FRESH value;
means for retaining an old FRESH value determined before the SRNS RELOCATION was received;
means for receiving a downlink (DL) message; and
means for applying both the old FRESH value and new FRESH value to the DL message to determine if the DL message is valid.

17. An apparatus for wireless communication, comprising:
at least one memory;
a Serving Radio Network Subsystem (SRNS) relocation component configured to:
receive a Serving Radio Network Subsystem (SRNS) RELOCATION message, and
initiate a handover procedure from a first radio network subsystem (RNS) to a second RNS based on the SRNS RELOCATION message; and
a message holding component in communication with the memory and configured to:
identify a downlink (DL) message,
identify an uplink (UL) message, and
hold the DL message and the UL message until completion of the handover procedure.

18. The apparatus of claim 17, wherein the DL message is received after the SRNS RELOCATION message but before completion of the handover procedure.

19. The apparatus of claim 17, wherein the DL message is received from the first RNS.

20. The apparatus of claim 17, wherein the message holding component comprises a communication component configured to transmit the DL message to a higher layer upon completion of the handover procedure.

21. The apparatus of claim 17, further comprising a higher layer configured to:
generate the UL message in response to the DL message; and
schedule the UL message for transmission to the network.

22. The apparatus of claim 17, wherein the message holding component comprises a communication component configured to transmit the UL message to the network upon completion of the handover procedure.

23. The apparatus of claim 17, wherein the SRNS RELOCATION message includes a new FRESH value, and further comprising an integrity protection component configured to:
retain an old FRESH value determined before the receiving; and
apply both the old FRESH value and new FRESH value to the DL message to determine if the DL message is valid.

24. An apparatus for wireless communication, comprising:
at least one memory;
a Serving Radio Network Subsystem (SRNS) relocation component configured to receive a Serving Radio Network Subsystem (SRNS) RELOCATION message, wherein the SRNS RELOCATION message includes a new FRESH value; and
an integrity protection component in communication with the memory and configured to:
retain an old FRESH value determined before the SRNS RELOCATION was received;
receive a downlink (DL) message; and
apply both the old FRESH value and new FRESH value to the DL message to determine if the DL message is valid.

25. The apparatus of claim 24,
wherein the SRNS relocation component is further configured to initiate a handover procedure from a first radio network subsystem (RNS) to a second RNS based on the receiving, and
wherein the DL message is received from the first RNS after the SRNS RELOCATION message, but before completion of the handover.

26. The apparatus of claim 25, wherein the new FRESH value is associated with the second RNS.

27. The apparatus of claim 24,
wherein the SRNS relocation component is further configured to initiate a handover procedure from a first radio network subsystem (RNS) to a second RNS based on the SRNS RELOCATION message, and
further comprising a message holding component configured to:
identify the DL message, wherein the DL message was received after the SRNS RELOCATION message was received but before completion of the handover procedure;
identify an uplink (UL) message, wherein the UL message is generated by a higher layer in response to the DL message and has been scheduled, by the higher layer, for transmission to the network; and
hold the DL message and the UL message until completion of the handover procedure.

28. The apparatus of claim 27, wherein the message holding component being configured to hold the DL message and the UL message comprises the message holding component configured to:
determine that the handover procedure has been completed;
retrieve the held DL message and UL message;
transmit the retrieved DL message to a higher layer; and
transmit the retrieved UL message to the network.
